(19) United States
(12) Patent Application Publication
(10) Pub. No.: US 2025/0115319 A1
(43) Pub. Date: Apr. 10, 2025

(54) Tipless Saddle with Pelvic Support Arrangement

(71) Applicant: Jian Xiang Ouyang, Temple City, CA (US)

(72) Inventor: Jian Xiang Ouyang, Temple City, CA (US)

(21) Appl. No.: 18/593,873

(22) Filed: Mar. 2, 2024

Related U.S. Application Data
(63) Continuation-in-part of application No. 18/377,728, filed on Oct. 6, 2023.

(51) Int. Cl. B62J 1/00; B62J 1/08

(52) U.S. Cl. CPC B62J 1/002; B62J 1/005; B62J 1/08

(57) ABSTRACT

A tipless saddle with pelvic support arrangement includes a saddle body, a rigid bottom base and a rail frame. The saddle body has a front pelvic support portion, a concave central recess extending from a rear end of the saddle body to the front pelvic support portion, and two buttock support surfaces gradually and symmetrically extended sidewardly and upwardly from two longitudinal sides of the central recess respectively, wherein the two buttock support surfaces have two curved retention surfaces inclinedly and upwardly extended to two tips of two sides of the saddle body respectively and symmetrically, wherein the front pelvic support portion and two front portions of the two buttock support surfaces integrally form a pelvic support arrangement of the tipless saddle. The rigid bottom base is coupled to an underside of the saddle body and the rail frame is secured to the bottom shell for mounting a saddle clamp.

### CROSS REFERENCE OF RELATED APPLICATION

This application is a Continuation-In-Part application that claims the benefit of priority under 35 U.S.C. § 120 to a non-provisional application, application Ser. No. 18/377,728, filed Oct. 6, 2023, which is incorporated herewith by reference in its entirety.

### BACKGROUND OF THE PRESENT INVENTION

### Field of Invention

The present invention relates to saddle, and more particularly to a tipless saddle with pelvic support arrangement for relaxed type bicycles, exercise machines and the like that provides proper pelvic support for the riders while eliminating the drawbacks of the nose of the saddle.

### Description of Related Arts

There are generally two types of bicycle, namely athletic type and relaxed type. For athletic type bicycle, as shown in FIG. 1A, the rider is preferred to ride in aerodynamic posture as shown in FIG. 2A or aggressive posture as shown in FIG. 2B with deep lean or moderate lean to have a spine angle up to 10°-30°, wherein an athletic bike saddle (as shown in FIG. 4A) with an elongated nose extended frontwardly is used to fit and support the pubic bones PB as illustrated in FIG. 5 while the rider is riding in racing posture (aerodynamic or aggressive posture) as shown in FIG. 6A and FIG. 6B. For relaxed type bicycle, as shown in FIG. 1B, the rider generally rides in relax posture as shown in FIG. 3A or fitness/leisure posture as shown in FIG. 3B with slight lean or upright position to have a spine angle approximately 60°-90°, wherein a wider comfort saddle (as shown in FIG. 4B) is used to support the sit bones (ischial tuberosity) as illustrated in FIG. 5 while the rider is riding in upright posture as shown in FIG. 6C.

While the nose of a bicycle saddle serves a functional purpose for athletic and aggressive posture, it also has various drawbacks as follows.
(i) The nose of a saddle can exert pressure on sensitive areas, particularly the perineal region. This pressure can cause discomfort, numbness, or even pain during long rides. Riders who spend extended periods on the saddle or those with specific anatomical considerations may be more prone to experiencing discomfort in this area.
(ii) The presence of a nose on the saddle can restrict the rider's movement and make it more challenging to shift their position on the saddle. This limitation can affect comfort and may cause additional strain or pressure on certain areas of the body.
(iii) Anatomical differences between genders can impact the comfort and fit of the saddle's nose. Some individuals, particularly women, may find that traditional saddle designs with pronounced noses do not accommodate their anatomy comfortably, leading to increased pressure or discomfort.
(iv) The nose of a saddle can potentially contribute to friction and rubbing against the inner thighs, particularly during more aggressive or dynamic riding styles. This friction can lead to skin irritation, chafing, or saddle sores, especially if proper positioning, adjustment, or protective measures are not taken.

Accordingly, choosing the right saddle that suits the rider's specific needs, taking into account factors such as saddle width, shape, and the presence of a nose, can help mitigate these potential drawbacks and enhance your overall cycling experience, especially for riders of relaxed type bicycles, riding comfortably for transportation is the top essence.

On the other hand, pelvic support is crucial for a bicycle saddle because it directly impacts rider comfort, stability, and overall cycling performance. It is well known that proper pelvic support helps distribute the rider's weight evenly across the saddle, reducing pressure on sensitive areas and preventing discomfort or pain during extended periods of cycling. It helps minimize the risk of numbness, chafing, or saddle sores.

Also, pelvic support enhances rider stability by providing a secure connection between the rider and the bike. It helps maintain proper body positioning, balance, and control, especially during more aggressive riding or challenging terrain. A stable pelvic foundation allows riders to pedal efficiently and maneuver their bikes effectively.

Referring to FIG. 4B, conventional comfort saddle has a wider seat for better pelvic support that facilitates effective power transfer from the rider's legs to the pedals. When the pelvis is properly supported, it allows for optimal alignment of the rider's legs, hips, and torso, promoting a more efficient pedaling motion and maximizing power output. However, the frontwardly extended tip portion (nose) of the conventional comfort saddle not only constitutes the above mentioned drawbacks, but also adversely affects the role of pelvic support in maintaining proper spine alignment while cycling. It front tip of the comfort saddle substantially blocks the distribution of the rider's weight through the pelvis that minimizes excessive pressure on the lower back.

Providing proper pelvic support for the rider is the core of saddle design and configuration to the manufacturers, that help the riders experience reduced fatigue and improved endurance. By providing stability, comfort, and efficient power transfer, especially for the comfort saddle for relaxed type bicycles, exercise machines and the like, a saddle with good pelvic support enables riders to maintain a more relaxed and efficient riding position, minimizing unnecessary muscle tension and fatigue.

### SUMMARY OF THE PRESENT INVENTION

The invention is advantageous in that it provides a tipless saddle which includes a pelvic support arrangement to provide pelvic support for the rider while a tip portion of the saddle is eliminated in the configuration of the saddle, so as to ensure the advantages of the good pelvic support while getting rid of the disadvantages of the tip portion (nose) of the saddle for relaxed type bicycles, exercise machines and the like.

Another advantage of the invention is to provide a tipless saddle with pelvic support arrangement to provide support to the ischium (sit bones) and the acetabulum (hip joint) of the skeleton of the human pelvic of the rider.

Another advantage of the invention is to provide a tipless saddle with pelvic support arrangement which includes portions shaped and configured to support the ischial tuberosity, ischial ramus and the rear portion of inferior ischial ramus of the pelvic of the rider.

Another advantage of the invention is to provide a tipless saddle with pelvic support arrangement which is adapted to well support the pelvic of the rider who is riding in an upright posture, slight lean posture and moderate lean posture.

Another advantage of the invention is to provide a tipless saddle with pelvic support arrangement which is configured to avoid pressure applied to the testicle and scrotum of male rider as well as the pudendal nerve and artery of the rider.

Another advantage of the invention is to provide a tipless saddle with pelvic support arrangement which is configured to avoid pressure applied to the pubic arch of the rider.

Another advantage of the invention is to provide a tipless saddle which has no tip portion and includes a pelvic support arrangement and a rail frame mounted on the underside of the saddle body and configured to mount the saddle clamp in a central and weight balancing manner so as to stably and firmly fasten the saddle body to the seatpost of a bicycle or exercise machine.

Another advantage of the invention is to provide a tipless saddle which reduces the leverage torque of the frontmost end with respect to the seatpost where the saddle clamp of the saddle mounted thereto that results in a more rigid and steady support to the saddle and the user riding on the saddle.

Another advantage of the invention is to provide a tipless saddle which comprises an additional rail bridge support to enhance the rigidity of the pair of rails of the rail frame. This configuration may further simplify the connection between the front end of the rail frame with saddle body.

Additional advantages and features of the invention will become apparent from the description which follows, and may be realized by means of the instrumentalities and combinations particular point out in the appended claims.

According to the present invention, the foregoing and other objects and advantages are attained by a tipless saddle, comprising:
a saddle body having a front pelvic support portion, a concave central recess extending from a rear end of the saddle body to the front pelvic support portion, and two buttock support surfaces gradually and symmetrically extended sidewardly and upwardly from two longitudinal sides of the central recess respectively, wherein the two buttock support surfaces have two curved retention surfaces inclinedly and upwardly extended to two tips of two sides of the saddle body respectively and symmetrically, wherein the front pelvic support portion and two front portions of the two buttock support surfaces integrally form a pelvic support arrangement of the tipless saddle;
a rigid bottom base coupled to an underside of the saddle body; and
a rail frame secured to the bottom shell for mounting a saddle clamp.

In one embodiment, the front pelvic support portion has two protruding ridges defined by front portions of the central recess and the two buttock support surfaces.

In one embodiment, the central recess has a rear end and a front end each having a wider width to define an air flow channel extending from the rear end to the front pelvic support portion for air ventilation while the rider is sitting on the saddle body.

In one embodiment, the rail frame comprises two rear rings arranged spacedly apart and configured to be secured to a pair of suspension units so as to mount to a rear portion of the bottom base, two front rings arranged spacedly apart and configured to be secured to a pair of front secure units so as to mount to a front portion of the bottom base, and a pair of rails parallelly extended between the two rear rings and the two front rings for mounting the saddle clamp which is configured to be fastened to a seatpost of the bicycle, exercise machine or the like.

In one embodiment, the rail frame comprises a two rear rings arranged spacedly apart and configured to be secured to a pair of suspension units so as to mount to a rear portion of the bottom base, a front end portion configured to be secured to a front secure unit of the rigid bottom base so as to mount to a front portion of the bottom base, and a pair of rails parallelly extended between the two rear rings and the front end portion for mounting the saddle clamp which is configured to be fastened to a seatpost of the bicycle, exercise machine or the like.

In one embodiment, the rail frame comprises a pair of rails and a rail bridge support rigidly fixed between a pair of rails to enhance a rigidity of the pair of rails of the rail frame.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A is a schematic view of an athletic type bicycle.

FIG. 1B is a schematic view of a relaxed type bicycle.

FIG. 2A is a schematic view illustrating an aerodynamic posture of a bicycle rider.

FIG. 2B is a schematic view illustrating an aggressive posture of a bicycle rider.

FIG. 3A is a schematic view illustrating a relax posture of a bicycle rider.

FIG. 3B is a schematic view illustrating a leisure posture of a bicycle rider.

FIG. 4A is a perspective view of an athletic saddle.

FIG. 4B is a perspective view of a comfort saddle.

FIG. 5 is a schematic view illustrating the racing posture and upright posture of the skeleton pelvic of human body.

FIG. 6A to FIG. 6C are schematic views illustrating positional relationships of the skeleton pelvic and the conventional saddle in the aerodynamic posture, aggressive posture and comfort posture respectively.

FIG. 7A and FIG. 7B are front perspective views of a tipless saddle with pelvic support arrangement according to a preferred embodiment of the present invention.

FIG. 8 is a rear perspective view of the tipless saddle with pelvic support arrangement according to the above preferred embodiment of the present invention.

FIG. 9 is a top view of the tipless saddle with pelvic support arrangement according to the above preferred embodiment of the present invention.

FIG. 10 is a front view of the tipless saddle with pelvic support arrangement according to the above preferred embodiment of the present invention.

FIG. 11 is a bottom perspective view of the tipless saddle with pelvic support arrangement according to the above preferred embodiment of the present invention.

FIG. 12 is a side view of the tipless saddle with pelvic support arrangement according to the above preferred embodiment of the present invention.

FIG. 13 is a bottom perspective view of the tipless saddle with a rail frame mounted thereto according to the above preferred embodiment of the present invention.

FIG. 14A is a bottom view of the tipless saddle with a rail frame mounted thereto according to the above preferred embodiment of the present invention.

FIG. 14B is a partially exploded bottom view of the tipless saddle according to the above preferred embodiment of the present invention.

FIG. 14C is a bottom view of a cushion body of the saddle body of the tipless saddle according to the above preferred embodiment of the present invention.

FIG. 15 is a schematic view illustrating a saddle clamp mounted to the rail frame of the tipless saddle according to the above preferred embodiment of the present invention.

FIG. 16A to FIG. 16C are schematic views illustrating positional relationships of the skeleton pelvic and the tipless saddle, in the aerodynamic posture, aggressive posture and comfort posture respectively, according to the above preferred embodiment of the present invention.

FIG. 17 is a schematic view illustrating positional relationship of the body of the rider and the tipless saddle according to the above preferred embodiment of the present invention.

FIG. 18 is a bottom view of an alternative mode of the tipless saddle with a rail frame mounted thereto according to the above preferred embodiment of the present invention.

FIG. 19 is an enlarged view of a front secure unit for the tipless saddle according to the alternative mode of the preferred embodiment of the present invention.

FIG. 20 is an enlarged view of another front secure unit for the tipless saddle according to the alternative mode of the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

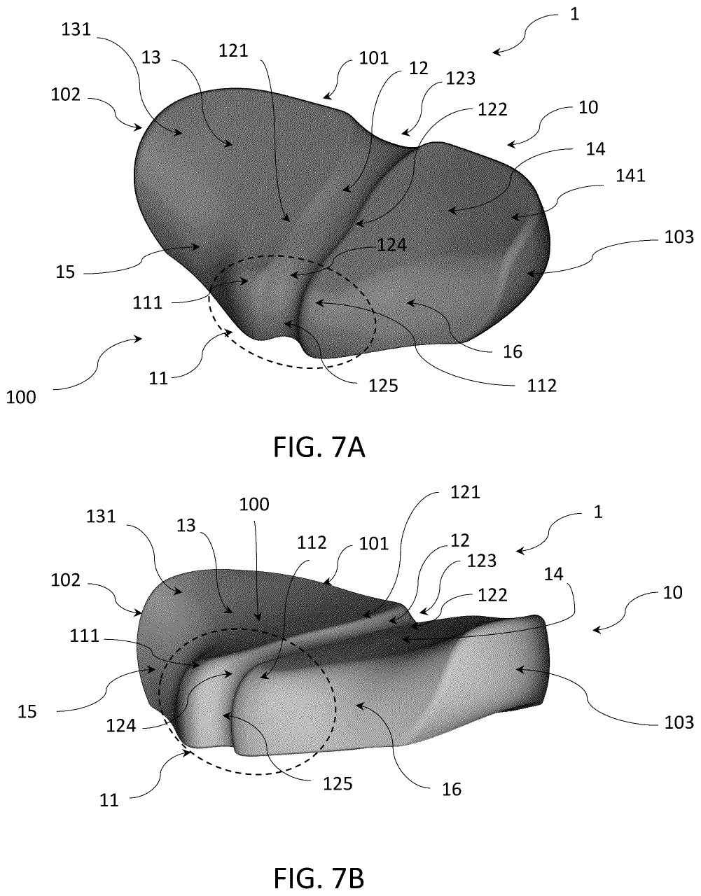

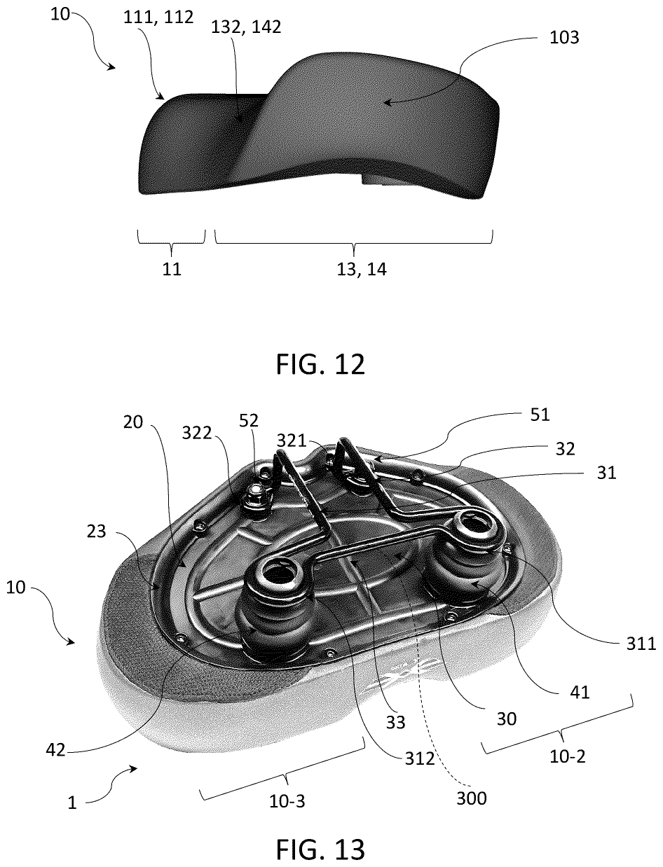

Referring to FIG. 7A to FIG. 15, a tipless saddle 1 with pelvic support arrangement 100 according to a preferred embodiment of the present invention is illustrated, wherein the tipless saddle 1 comprises a saddle body 10 and a rigid bottom base 20 made of rigid material such as moulded plastic, nylon, carbon fiber, and etc., wherein the saddle body 10 is affixed on the bottom base 20.

In order to mount the tipless saddle 1 to a bicycle or an exercise bike, the tipless saddle 1 further comprises a rail frame 30 as illustrated in FIG. 13 to FIG. 15 configured for mounting a saddle clamp 40 as shown in FIG. 15 for fastening to a seatpost (not shown) of the bicycle or the exercise bike.

According to the preferred embodiment, referring to FIG. 7A to FIG. 9 the cushioned saddle body 10 has a front pelvic support portion 11, a concave central recess 12 extending from a rear end 101 of the saddle body 10 to the front pelvic support portion 11, and two buttock support surfaces 13, 14 gradually and symmetrically extended sidewardly and upwardly from two longitudinal sides 121, 122 of the central recess 12 respectively, wherein each of the two buttock support surfaces 13, 14 have two curved retention surfaces 131, 142 inclinedly and upwardly extended to two tips of two sides 102, 103 respectively and symmetrically, wherein the front pelvic support portion 11, the two buttock support surfaces 13, 14 and the two thigh support surfaces 15, 16 integrally form a pelvic support arrangement 100 of the tipless saddle 10.

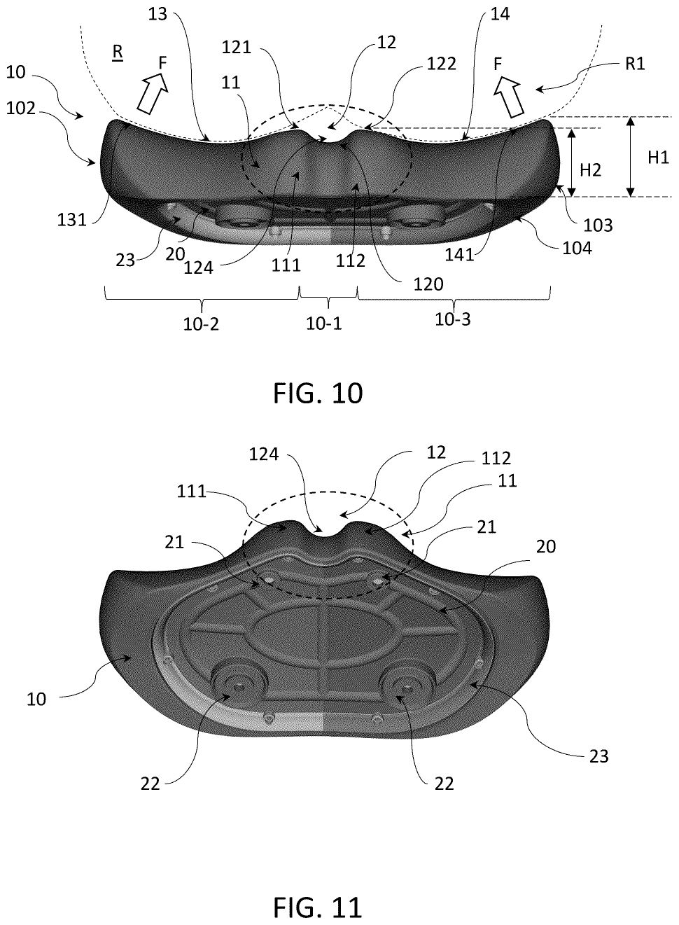

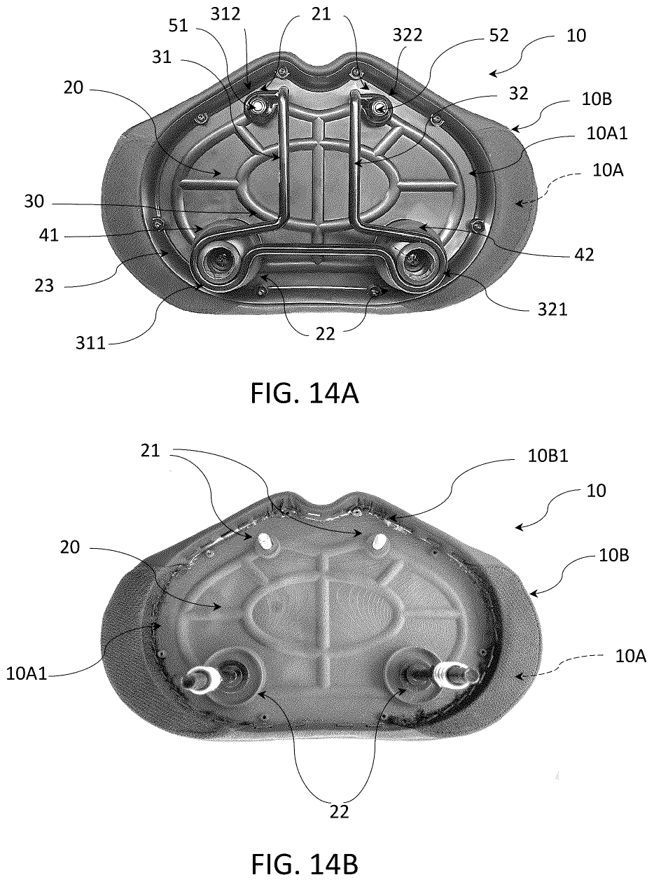

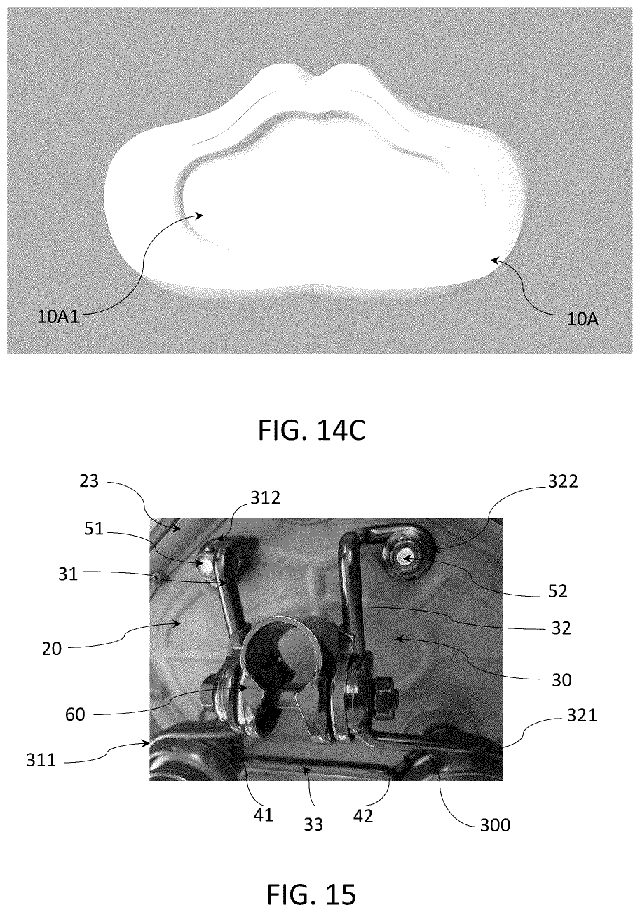

Referring to FIGS. 10, 11, 14B, and 14C, according to the preferred embodiment, the saddle body 10 comprises a seat body 10A made of cushion and padding material such as cell form, gel, gel-foam, and etc., and a cover 10B made of leather, nylon, artificial leather, spandex and the like, as shown in FIG. 14B. It is appreciated that while the saddle body 10 does not require cushion effect, the saddle body 10 can be a hard shell made of leather, moulded piece of plastic, nylon or carbon fiber material to include the front pelvic support portion 11, the central recess 12, the two buttock support surfaces 13, 14, and the two thigh support surfaces 15, 16 as described above and a bottom of the hard shell forms the bottom base 20 for mounting the rail frame 30 thereon.

According to the preferred embodiment, the seat body 10A has a bottom groove 10A1 and the bottom base 20 is shaped and configured to be fittingly affixed therein. FIG. 14C illustrates an example of such padding seat body 10A having the bottom groove 10A1 that can be used as the seat body 10A of the present invention. The seat body 10A is shaped and configured to include the front pelvic support portion 11, the central recess 12, the two buttock support surfaces 13, 14, and the two thigh support surfaces 15, 16. After the bottom base 20 is affixed in the bottom groove 10A1 of the seat body 10A by adhering, for example, the cover 10B is preferred to be fittingly attached around the seat body 10A and a peripheral edge of the bottom base 20, as shown in FIG. 14B.

Referring to FIG. 11, FIG. 14A and FIG. 14B, in order to mount the rail frame 30 to the bottom base 20, the bottom base 20 further comprises a pair of front mounting members 21 and a pair of rear mounting members 22 integrally provided thereon and a secure rim 23 affixed by screwing thereto to cover the peripheral edge of the bottom base 20 and the surrounding edge 10B1 of the cover 10B, as shown in FIG. 14A, and to further secure the cover 21 in position.

Referring to FIG. 7A to FIG. 10, the saddle body 10 is configured to have a butterfly shape, defining the rear end 101, two sides 102, 103 and the front pelvic support portion 11, and a predetermined thickness, wherein an overall size of the saddle body 10 has a transverse width (distance between the two sides 102, 103, ranged 15-22 cm, preferably 19 cm) at least wide enough and a longitudinal length (distance between the rear end 101 and the front pelvic support portion 11, ranged 25-35 cm, preferably 32 cm) long enough to support the ischium (sit bones) of the human pelvic of the rider, such as child, male and female, in different ages and sizes. It is appreciated to the configuration of the front pelvic support portion 11 which is provided to support the ischial tuberosity, ischial ramus and the rear portion of inferior ischial ramus of the pelvic of the rider in relax and comfort riding postures, so that the saddle body 10 of the present invention can eliminate the tip or nose portion that substantially avoids pressure applied to the testicle and scrotum of male rider as well as the pudendal nerve and artery of the rider.

The concave central recess 12, configured to be positioned below the pubic arch (arcus ossium pubis) and gluteal cleft of the rider sat on the saddle body 10, has a predetermined width, ranged 2-6 cm and preferably 4 cm, to avoid pressure applied to the pubic arch of the rider and allow air ventilation therethrough while the rider is sitting on the saddle body 10, wherein a curved bottom surface 120 is preferably formed to define the concave central recess 12 that facilitates the air ventilation and the two longitudinal sides 121, 122 of the central recess are smoothly extended to the two buttock support surfaces 13, 14 respectively, as shown in FIG. 9 to FIG. 11. In addition, the central recess 12 further has an enlarged rear end opening 123, an enlarged front end opening 124 and an enlarged center reservoir 125, as shown in FIG. 9. In other words, each of the two longitudinal sides 121, 122 of the central recess 12 has a wave shape to define the enlarged rear end opening 123, the enlarged front end opening 124 and the enlarged center reservoir 125, such that the central recess 12 forms an air flow channel having a turbulent airflow enhancing the air ventilation therethrough.

The two buttock support surfaces 13, 14 are symmetrical curved surfaces gradually extended sidewardly and upwardly from the two longitudinal sides 121, 122 of the central recess 12 to the two sides 102, 103 of the saddle body 10, respectively, wherein, referring to FIG. 10, a height H1 from a bottom surface 104 of the saddle body 10 to the two sides 102, 103 is higher than a height H2 from the bottom surface 104 to the two longitudinal sides 121, 122, forming two wing supports 10-2 and 10-3 of the saddle body 10 of the saddle body 10 integrally combined with a middle support 10-1 to construct the saddle body 10.

Referring to FIG. 10, a curvature of each of the two buttock support surfaces 13, 14 is configured to match and conform to the curvature of the buttock R1 of the rider R while sitting on the saddle body 10. Accordingly, the two sides 102, 103 are two elevated side supports forming the two curved retention surfaces 131, 141 of the two buttock support surfaces 13, 14 inclinedly and upwardly extended to two tips of the two sides 102, 103 for reinforcing the two wing supports 10-2, 10-3 in a tilt up manner so as to prevent the two wing supports 10-2, 10-3 being sagged down under pressure and thus provide upward and inward supporting force F (see arrows as illustrated in FIG. 10) to support the buttock R1 as well as hip of the rider R that significantly ensures a comfort riding for the rider R.

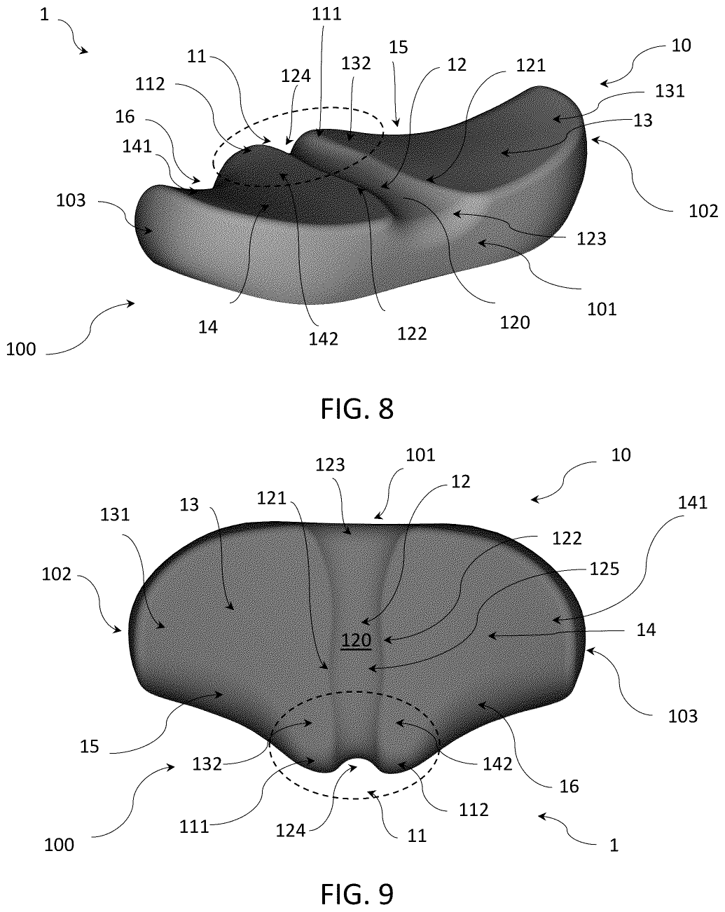

Referring to FIG. 7A to FIG. 12, the front pelvic support portion 11 has two protruding ridges 111, 112 defined by front portions of the central recess 12, the two buttock support surfaces 13, 14. The front opening 124 of the central recess 12 extends vertically and downwardly to form a front recess 125 dividing a front portion of the saddle body 10 into the two protruding ridges 111, 121. In other words, the two protruding ridges 111, 121 are positioned at the front opening 124 of the central recess 12 and the front recess 125 and gradually protruded from the two buttock support surfaces 13, 14, i.e. the two wing supports 10-2, 20-3, respectively. According to the preferred embodiment of the present invention, the two protruding ridges 111, 121 are arranged for restricting a comfort and stable sitting posture for the rider R in such a manner that the front pelvic support portion 11 can ensure a good pelvic support for the rider while getting rid of the disadvantage of the tip/nose portion of the conventional saddle. According to the preferred embodiment of the present invention, the front pelvic support portion 11 and two inclined and curved front portions 132, 142 of the two buttock support surfaces 13, 14 integrally form a pelvic support arrangement of the tipless saddle 1 of the present invention, as shown in FIGS. 8-9, 11.

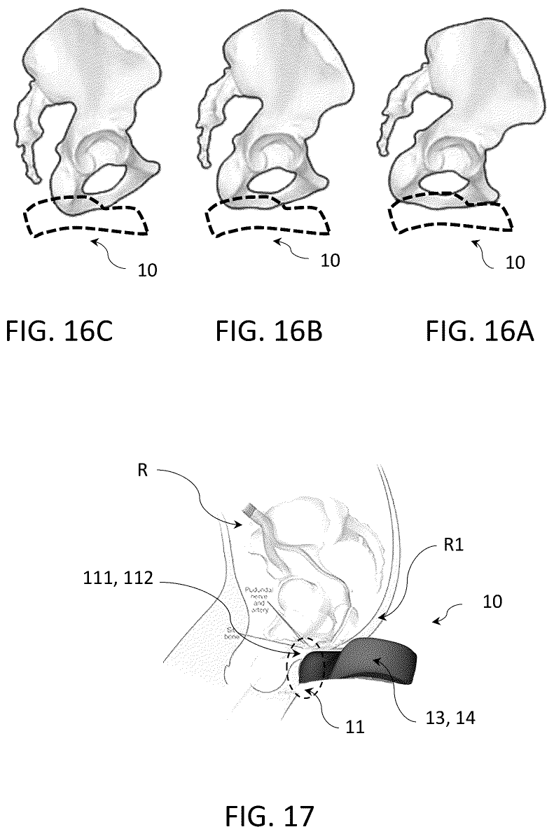

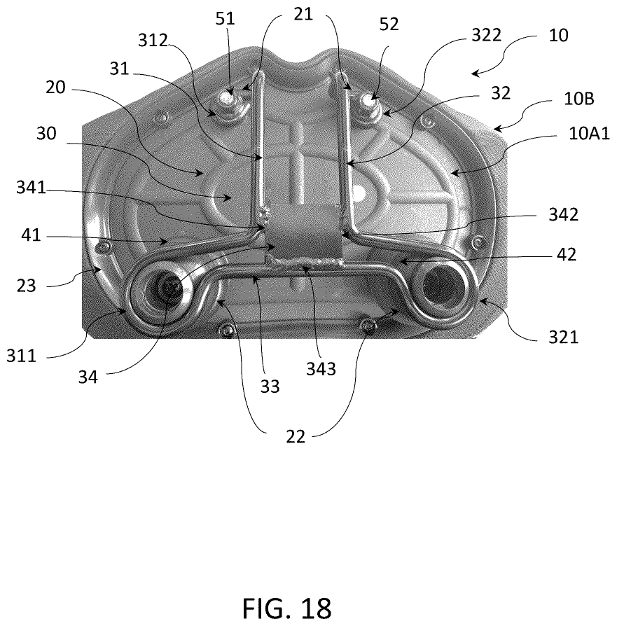

As shown in FIGS. 10-12, 16A-16C, and 17, while the rider R sits on the saddle body 10 in a comfort and relax posture, including the upright posture as shown in FIG. 16A, the slight lean posture as shown in FIG. 16B and moderate lean posture as shown in FIG. 16C, the buttock R1 of the rider is sit and supported by two buttock support surfaces 13, 14 of the saddle body 10, i.e. supporting by the two wing supports 10-2, 10-3, wherein the two protruding ridges 111, 112 provide a restriction to the riding posture of the rider R such that the front pelvic support portion is shaped and configured to support the ischial tuberosity, ischial ramus and the rear portion of the inferior ischial ramus of the pelvic of the rider.

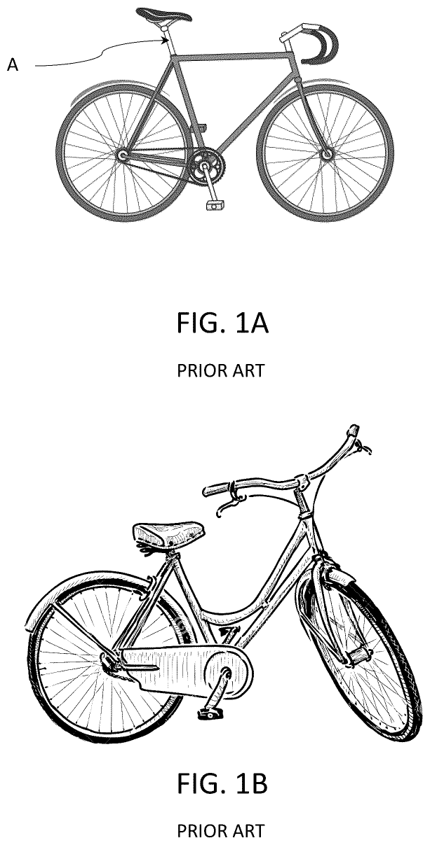

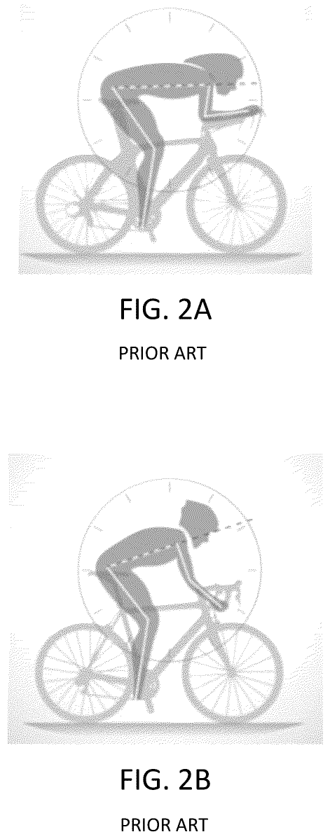

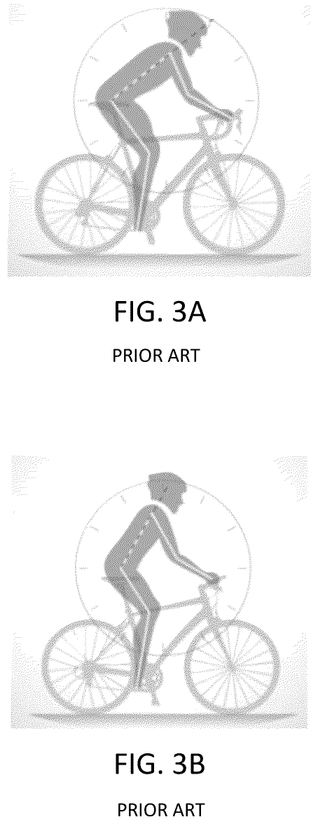

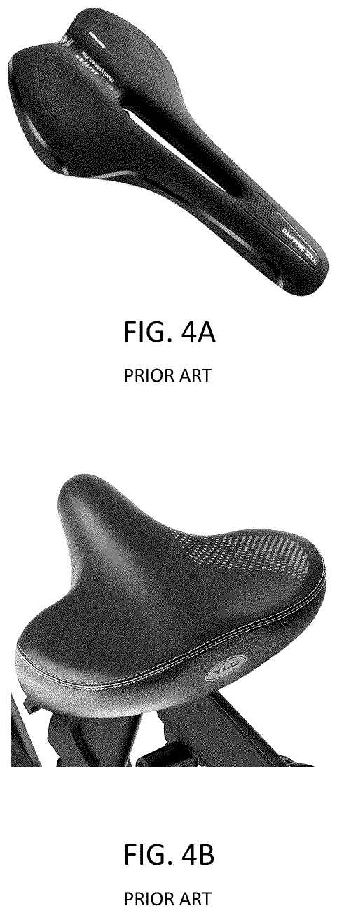

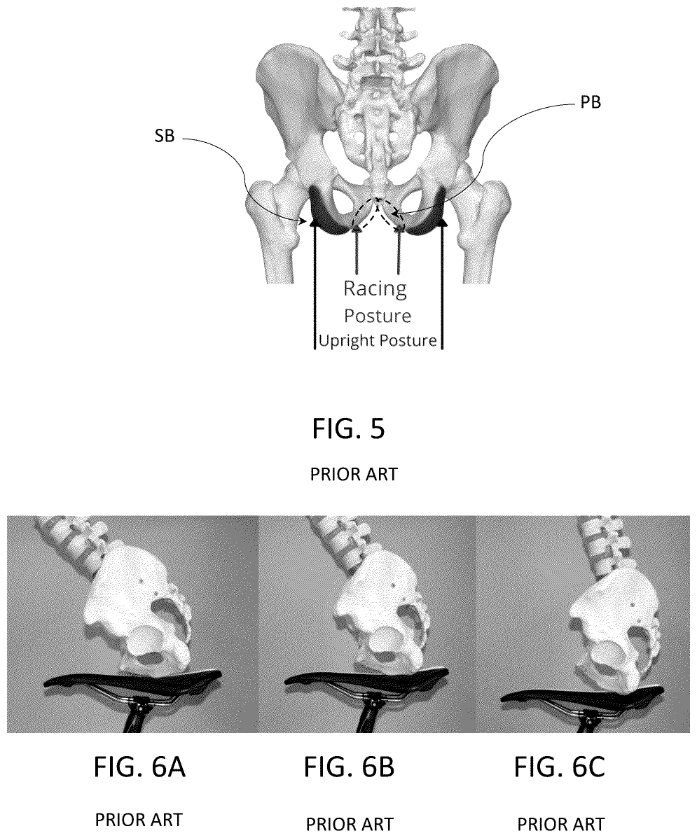

The removal of the tip/nose portion of the saddle and the presence of the front opening 124 and front recess 125 of the central recess 12 prevents any pressure applied to the testicle and scrotum of male rider as in the conventional saddle, as shown in FIG. 1A and FIG. 1B, the configuration of front pelvic support portion 11 and the two buttock support surfaces 13, 14 according to the present invention substantially provide comfort and stable sitting posture for the rider R, especially for comfort and relax riding.

In order to securely and stably mount the saddle body to a seatpost of a bicycle, exercise machine or etc., referring to FIG. 13, FIG. 14A and FIG. 15, the rail frame 30 is configured to comprise a pair of rails 31, 32, two rear rings 311, 321 arranged spacedly apart and configured to be secured to a pair of suspension units 41, 42 so as to mount to a rear portion of the bottom base 20, and two front rings 312, 322 arranged spacedly apart and configured to be secured to a pair of front secure units 51, 52 so as to mount to a front portion of the bottom base 20, wherein the pair of rails 31, 32 parallelly extended between the two rear rings 311, 312 and the two front rings 321, 322 for mounting a saddle clamp 60 (as shown in FIG. 15) which is configured to be fastened to the seatpost of the bicycle, exercise machine or the like.

Since the saddle body 10 is shorter than that of the conventional saddle while eliminating the tip/nose portion, the rail frame 30 is specifically configured according to the present invention to provide a balance and steady support of the saddle clamp 60 so as to mount to the seatpost (such as the reference character A as shown in FIG. 1A) generally at a center of gravity of the saddle body 10. Such balance and steady configuration of the rail frame 30 is implemented by bending one metal rod 300 to integrally form the pair of rails 31, 32, the two rear rings 311, 321, and the two front rings 312, 322. Please referring to FIG. 13 and FIG. 15, two ends of the metal rod 300 is bent sidewardly and outwardly to form the two front rings 321, 322 in C-shaped for securing to the bottom base 30 by screwing with the pair of front secure units 51, 52 (embodied as a pair of bolts and nuts according to the preferred embodiment of the present invention), and then bent downwardly for a predetermined height, generally the height of the suspension units 41, 42, and bent rearwardly to form the two parallel rails 31, 32. The middle portion of the metal rod 300 is bent to form a transverse bar 33 extended perpendicularly to the two rails 31, 32 and between the two suspension units 41, 42. Two rear ends of the pair of rails 31, 32 and two ends of the transverse bar 33 further extend and bend sidewardly and outwardly to form the two rear rings 311, 312 respectively for secured to the pair of suspension units 41, 42 by a pair of bolts and nuts, wherein the two rear rings 311, 321 and the two front rings 321, 322 are outwardly extended and formed at two side positions of the pair of rails 31, 32, such that the length of the pair of rails 31, 32 are minimized but long enough to mount the saddle clamp 40 across the pair of rails 31, 32, while providing two front fulcrums to support the front pelvic support portion 11 and two rear fulcrums to support the two wing supports 10-2, 10-3 so that the saddle body 10 is able to be fixedly mount to the seatpost in a balance and stable manner.

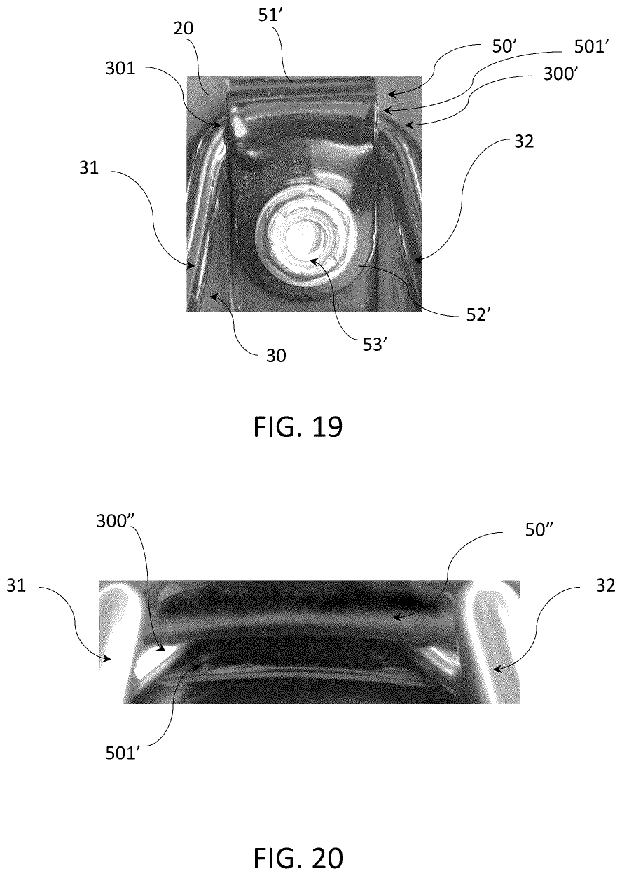

Referring to FIG. 19, an alternative mode of the tipless saddle according to the preferred embodiment of the present invention is illustrated, wherein the rail frame 30 further comprises a rail bridge support 34 rigidly fixed between the pair of rails 31, 32 of the rail frame 30. The rail bridge support 34 significantly reinforces the two rails 31, 32 and ensures a distance between the two rails 31, 32 so as to further support the two front rings 312, 322 and the two rear rings 311, 321 to form a rigid configuration for ease of securing with the pair of front secured units 51, 52 and the rear mounting members 22.

Preferably, the rail bridge support 34 is embodied as a supporting panel have two opposing sides 341, 342 integrally affixed to rear positions of the two rails 31, 32 and one side 343 integrally affixed to a rear rail 33 connected between the two rear rings 311, 321 while the saddle clamp 60 is mounted between the two rails 31, 32 adjacent to the rail bridge support 34 for mounting to the seatpost of the bicycle, exercise or the like. Accordingly, by means of the rail bridge support 34, the two rails 31, 32 and the rear rail 33 are interconnected to form a rigid body to support the saddle body 10 rigidly and steadily, especially while an over weight user is riding on the tipless saddle.

Since the tipless saddle significantly reduces a leverage torque of a frontmost end with respect to the seatpost where the saddle clamp 60 of the tipless saddle mounted thereto that results in a more rigid and steady support to the saddle and the user riding on the saddle, it may further simplify the connection between the front end of the rail frame 30 with saddle body 10.

Referring to FIG. 19, an alternative front secure unit 50′ is embodied to substitute the pair of front secure units 51, 52 is illustrated. Correspondingly, the rail frame 30 has a front arm 301 integrally extended between two front ends of the pair of rails 31, 32, wherein the front arm 301 and the two front ends of the pair of rails 31, 32 form a U-shaped front portion 300′ of the rail frame 30 to substitute the two front rings 312, 322 as shown in FIG. 13 and FIG. 14A. The front secure unit 50′ comprises a securing bracket 51′ which one end 51′ connected to the bottom base 20 and another end extended across the front arm 301 to form a securing member 52′ for detachably connected to the bottom base 20 through a securing element 53′ such as a screw. The securing bracket 52′ further has a securing groove 501′ formed between the two ends thereof, which is sized and shaped to fittingly receive the front arm 301 therein so as to securely hold and affix the U-shaped front portion 301 of the rail frame 30 in position. Accordingly, the front secure unit 50′ and the two rear mounting members 22 form a rigid triangular configuration to support the saddle body 10 in a balance and stable manner.

Referring to FIG. 20, anther alternative front secure unit 50′ is illustrated, wherein the pair of front secure units 51, 52 as shown in FIG. 13 and FIG. 14A are replaced by a front secure unit 50′ and two front ends of the pair of rails 31, 32 are extended frontwardly to from a V-shape front end member 300″. The front secure unit 50′ is integrally provided on the bottom base 20 and has an engaging slot 501″ facing rearwards to engage with the front end member 300″ of the rail frame 30, wherein the engaging slot 501″ is sized and shaped to engage with front end member 300″ so as to securely hold and affix the front end member 300″ of the rail frame 30 in position. Accordingly, the front secure unit 50″ and the two rear mounting members 22 form a rigid triangular configuration to support the saddle body 10 in a balance and stable manner.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A tipless saddle, comprising
a saddle body having a front pelvic support portion a central recess extending from a rear end of said saddle body to said front pelvic support portion, and two buttock support surfaces gradually and symmetrically extended sidewardly and upwardly from two longitudinal sides of said central recess respectively, wherein said two buttock support surfaces have two curved retention surfaces inclinedly and upwardly extended to two tips of two sides of said saddle body respectively and symmetrically, wherein said front pelvic support portion and two front portions of said two buttock support surfaces integrally form a pelvic support arrangement of said tipless saddle;
a rigid bottom base coupled to an underside of said saddle body; and
a rail frame, which is secured to said bottom base for mounting a saddle clamp, comprising two rear rings arranged spacedly apart and configured to be secured to a pair of suspension units so as to mount to a rear portion of said bottom base, a front secure unit provided at a front portion of said bottom base, and a pair of rails parallelly extended between said two rear rings and said front secure unit for mounting the saddle clamp.

2. The tipless saddle, as recited in claim 1, wherein said rail frame further comprises a rail bridge support rigidly fixed between said pair of rails so as to reinforce said pair of rails and ensure a distance between said pair of rails.

3. The tipless saddle, as recited in claim 2, wherein said rail frame comprise two rear rings arranged spacedly apart and configured to be secured to a pair of suspension units so as to mount to a rear portion of said bottom base, wherein said rail bridge support is a panel having two opposing sides integrally affixed to rear positions of said pair of rails and one side integrally affixed to a rear rail connected between said two rear.

4. The tipless saddle, as recited in claim 2, wherein said front pelvic support portion has two protruding ridges defined by a front portion of said central recess and said two front portions of said two buttock support surfaces.

5. The tipless saddle, as recited in claim 2, wherein a front opening of said central recess extends vertically and downwardly to form a front recess dividing a front portion of said saddle body into said two protruding ridges which are positioned at said front opening of said central recess and said front recess and gradually protruded from said two buttock support surfaces, wherein said two front portions of said buttock support surfaces are two inclined and curved front surfaces configured to implement with said two protruding ridges of said front pelvic support portion integrally form said pelvic support arrangement of said tipless saddle.

6. The tipless saddle, as recited in claim 4, wherein a front opening of said central recess extends vertically and downwardly to form a front recess dividing a front portion of said saddle body into said two protruding ridges which are positioned at said front opening of said central recess and said front recess and gradually protruded from said two buttock support surfaces, wherein said two front portions of said buttock support surfaces are two inclined and curved front surfaces configured to implement with said two protruding ridges of said front pelvic support portion integrally form said pelvic support arrangement of said tipless saddle.

7. The tipless saddle, as recited in claim 2, wherein said two buttock support surfaces are symmetrical curved surfaces gradually extended sidewardly and upwardly from said two longitudinal sides of said central recess and said two sides of said saddle body respectively, wherein a height from a bottom surface of said saddle body to said two sides is higher than a height from said bottom surface to said two longitudinal sides, forming two wing supports of said saddle body integrally, wherein said two sides of said saddle body are two elevated side supports respectively forming two curved retention surfaces of said two buttock support surfaces inclinedly and upwardly extended to two tips of said two sides for reinforcing said two wing supports in a tilt up manner so as to prevent said two wing supports being sagged down under pressure and provide upward and inward supporting capability.

8. The tipless saddle, as recited in claim 4, wherein said two buttock support surfaces are symmetrical curved surfaces gradually extended sidewardly and upwardly from said two longitudinal sides of said central recess and said two sides of said saddle body respectively, wherein a height from a bottom surface of said saddle body to said two sides is higher than a height from said bottom surface to said two longitudinal sides, forming two wing supports of said saddle body integrally, wherein said two sides of said saddle body are two elevated side supports respectively forming two curved retention surfaces of said two buttock support surfaces inclinedly and upwardly extended to two tips of said two sides for reinforcing said two wing supports in a tilt up manner so as to prevent said two wing supports being sagged down under pressure and provide upward and inward supporting capability.

9. The tipless saddle, as recited in claim 5, wherein said two buttock support surfaces are symmetrical curved surfaces gradually extended sidewardly and upwardly from said two longitudinal sides of said central recess and said two sides of said saddle body respectively, wherein a height from a bottom surface of said saddle body to said two sides is higher than a height from said bottom surface to said two longitudinal sides, forming two wing supports of said saddle body integrally, wherein said two sides of said saddle body are two elevated side supports respectively forming two curved retention surfaces of said two buttock support surfaces inclinedly and upwardly extended to two tips of said two sides for reinforcing said two wing supports in a tilt up manner so as to prevent said two wing supports being sagged down under pressure and provide upward and inward supporting capability.

10. The tipless saddle, as recited in claim 6, wherein said two buttock support surfaces are symmetrical curved surfaces gradually extended sidewardly and upwardly from said two longitudinal sides of said central recess and said two sides of said saddle body respectively, wherein a height from a bottom surface of said saddle body to said two sides is higher than a height from said bottom surface to said two longitudinal sides, forming two wing supports of said saddle body integrally, wherein said two sides of said saddle body are two elevated side supports respectively forming two curved retention surfaces of said two buttock support surfaces inclinedly and upwardly extended to two tips of said two sides for reinforcing said two wing supports in a tilt up manner so as to prevent said two wing supports being sagged down under pressure and provide upward and inward supporting capability.

11. The tipless saddle, as recited in claim 2, wherein said front secure unit of said rail frame comprises two front rings arranged spacedly apart and configured to be secured to a pair of front secure units so as to mount to a front portion of said bottom base.

12. The tipless saddle, as recited in claim 10, wherein said front secure unit of said rail frame comprises two front rings arranged spacedly apart and configured to be secured to a pair of front secure units so as to mount to a front portion of said bottom base.

13. The tipless saddle, as recited in claim 2, wherein said rail frame has a front arm integrally extended between two front ends of said pair of rails, wherein said front arm and said two front ends of said pair of rails form a U-shaped front portion of said rail frame, wherein said front secure unit comprises a securing bracket which one end connected to said bottom base and another end extended across said front arm to form a securing member for detachably connected to said bottom base through a securing element, wherein said securing bracket further has a securing groove formed between said two ends thereof, which is sized and shaped to fittingly receive said front arm therein so as to securely hold and affix said U-shaped front portion of said rail frame in position.

14. The tipless saddle, as recited in claim 10, wherein said rail frame has a front arm integrally extended between two front ends of said pair of rails, wherein said front arm and said two front ends of said pair of rails form a U-shaped front portion of said rail frame, wherein said front secure unit comprises a securing bracket which one end connected to said bottom base and another end extended across said front arm to form a securing member for detachably connected to said bottom base through a securing element, wherein said securing bracket further has a securing groove formed between said two ends thereof, which is sized and shaped to fittingly receive said front arm therein so as to securely hold and affix said U-shaped front portion of said rail frame in position.

15. The tipless saddle, as recited in claim 2, wherein two front ends of said pair of rails are extended frontwardly to from a V-shape front end member, wherein said front secure unit is integrally provided on said bottom base and has an engaging slot facing rearwards to engage with said front end member of said rail frame, wherein said engaging slot is sized and shaped to engage with said front end member so as to securely hold and affix said front end member of said rail frame in position.

16. The tipless saddle, as recited in claim 10, wherein two front ends of said pair of rails are extended frontwardly to from a V-shape front end member, wherein said front secure unit is integrally provided on said bottom base and has an engaging slot facing rearwards to engage with said front end member of said rail frame, wherein said engaging slot is sized and shaped to engage with said front end member so as to securely hold and affix said front end member of said rail frame in position.

17. The tipless saddle, as recited in claim 2, wherein said central recess is a concave recess having an enlarged rear end opening, an enlarged front end opening and an enlarged center reservoir, such that said central recess forms an air flow channel for air ventilation therethrough, wherein a curvature of each of said two buttock support surfaces is configured for matching and conforming to a buttock of a rider of said tipless saddle while sitting on said saddle body.

18. The tipless saddle, as recited in claim 5, wherein said central recess is a concave recess having an enlarged rear end opening, an enlarged front end opening and an enlarged center reservoir, such that said central recess forms an air flow channel for air ventilation therethrough, wherein a curvature of each of said two buttock support surfaces is configured for matching and confronting a buttock of a rider of said tipless saddle while sitting on said saddle body.

19. The tipless saddle, as recited in claim 7, wherein said central recess is a concave recess having an enlarged rear end opening, an enlarged front end opening and an enlarged center reservoir, such that said central recess forms an air flow channel for air ventilation therethrough, wherein a curvature of each of said two buttock support surfaces is configured for matching and conforming to a buttock of a rider of said tipless saddle while sitting on said saddle body.

20. The tipless saddle, as recited in claim 9, wherein said central recess is a concave recess having an enlarged rear end opening, an enlarged front end opening and an enlarged center reservoir, such that said central recess forms an air flow channel for air ventilation therethrough, wherein a curvature of each of said two buttock support surfaces is configured for matching and conforming to a buttock of a rider of said tipless saddle while sitting on said saddle body.
